(19) United States
(12) Patent Application Publication
(10) Pub. No.: US 2007/0231633 A1
(43) Pub. Date: Oct. 4, 2007

(54) FUEL SYSTEM AND FUEL CELL SYSTEM

(75) Inventors: Hideo KITAMURA, Yokohama-shi (JP); Yoshiyuki Isozaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/683,167

(22) Filed: Mar. 7, 2007

(30) Foreign Application Priority Data
Mar. 30, 2006 (JP) 2006-095235

(51) Int. Cl. H01M 8/06; H01M 8/04

(52) U.S. Cl. 429/20; 429/25; 429/22

(57) ABSTRACT

A fuel system includes: a fuel vessel storing an organic raw material which has a higher saturated vapor pressure than the atmospheric pressure; a first flow rate unit regulating a flow rate of the organic raw material supplied from the fuel vessel; a reforming unit reforming at least a part of the organic raw material supplied from the first flow rate unit into hydrogen-containing gases; a combustion unit burning at least a part of the hydrogen-containing gases supplied from the reforming unit and discharging combustion gases; a second flow rate unit regulating a flow rate of the combustion gases discharged from the combustion unit according to pressure of the organic raw material in the fuel vessel; and a vessel heating unit arranged around the fuel vessel to heat the fuel vessel by using the combustion gases supplied from the second flow rate unit.

### CROSS-REFERENCE TO RELATED APPLICATIONS

This application is based upon and claims the benefit of priority from Japanese Patent Application No. 2006-095235, filed on Mar. 30, 2006, the entire contents of which are incorporated herein by reference.

### BACKGROUND

1. Field

The present invention relates to a fuel system and a fuel cell system.

2. Description of the Related Art

In recent years, as a small-sized electric power supply for portable electronic devices, which support information society, fuel cell systems and ultra micro-gas turbines, which are driven by hydrogen, are increasingly expected.

In particular, dimethyl ether is promising as a fuel used in these systems. This is because dimethyl ether can be easily liquefied. Further, dimethyl ether has an advantage that since its saturated vapor pressure at room temperature is about 6 atmospheric pressure higher than the atmospheric pressure, there is no need for a pump that feeds a fuel to a fuel cell system or an ultra micro-gas turbine.

Also, while it is generally necessary in these systems to use transforming means to reform a fuel to produce hydrogen-containing gases, dimethyl ether can be reformed at low temperature as compared with the case where natural gases, etc. are used as a fuel, and has an advantage that it does not contain a sulfur content which deteriorate a reforming catalyst.

However, in case of supplying a fuel containing dimethyl ether to a fuel cell system or an ultra micro-gas turbine, the fuel is supplied by the use of its pressure without the use of a pump, so that a flow rate of a fuel supplied from a fuel vessel is decreased due to pressure drop in the fuel vessel. For example, in case of vaporizing a fuel in the fuel vessel to supply the same in a gaseous state, pressure in the fuel vessel drops and a flow rate of a fuel decreases when fuel temperature decreases due to heat of vaporization of dimethyl ether. Also, even in case of supplying a fuel in a liquid state, dimethyl ether vaporizes corresponding to a decrease in liquid phase volume in the vessel. Therefore, pressure in the fuel vessel drops and a flow rate of a fuel decreases. Further, pressure in the fuel vessel can vary according to a change in temperature of an external environment. For example, the saturated vapor pressure of dimethyl ether alone is 6 atmospheric pressure at temperature of 25 degrees Celsius but decreases to 4 atmospheric pressure at temperature of 10 degrees Celsius.

Here, orifices, needle valves, bellows valves, diaphragm valves, butterfly valves, etc. are known as means that controls a flow rate of a fuel supplied from a fuel vessel. When pressure in the fuel vessel drops for the reason described above, an actual flow rate becomes less than a set flow rate of the means described above. As a result, it may be impossible to control a flow rate of a fuel. There are measures to control the flow rate, for example, as follows: measures of increasing an opening degree of a flow control valve according to pressure drop; or, in case of using an orifice, measures of introducing a fuel into the orifice after a pressure regulator mounted on an upstream side is set to regulate a downstream pressure to a certain low value. However, in the case where pressure drop in the fuel vessel is considerable, there is a fear that failure occurs in control of a flow rate of a fuel even when these measures are used.

Hereupon, in a field of a fuel cell system using butane gases as liquefied gases, there have been provided a system to adjust an amount of butane gases to be vaporized by heating a tank as a fuel vessel with the use of exhaust heat from a reforming device (for example, International Publication No. WO98/00878).

According to the system disclosed in WO98/00878, a flow passage control plate is used to regulate a flow rate of exhaust gases discharged from a reforming device, and the exhaust gases are then fed to a tank. In this way, the system controls temperature of the tank to keep the temperature in a predetermined range thereby adjusting an amount of butane gases to be vaporized so that the amount is kept constant.

However, the system described in WO98/00878 includes means for measurement of temperature of the tank as a fuel vessel, and a control circuit that operates the flow passage control plate according to measured temperature, etc. As a result, the system becomes large in size. The system is preferably small in size since the large sized system cannot be used as a small-sized electric power supply for portable electronic devices Also, it is necessary to provide extra electric power for driving of the flow passage control plate in the system. Further, in the case where the control circuit is in failure, there is caused inconvenience in modulating a flow of exhaust gases and pressure in the tank is considerably increased or decreased.

### SUMMARY

According to a first aspect of the invention, a fuel system comprises: a fuel vessel storing an organic raw material which having has a higher saturated vapor pressure than the atmospheric pressure; a first flow rate unit regulating a flow rate of the organic raw material supplied from the fuel vessel; a reforming unit reforming at least a part of the organic raw material supplied from the first flow rate unit into hydrogen-containing gases; a combustion unit burning at least a part of the hydrogen-containing gases supplied from the reforming unit and discharging combustion gases; a second flow rate unit regulating a flow rate of the combustion gases discharged from the combustion unit according to pressure of the organic raw material in the fuel vessel; and a vessel heating unit arranged around the fuel vessel to heat the fuel vessel by using the combustion gases supplied from the second flow rate unit.

According to a second aspect of the invention, a fuel system comprises: a fuel vessel storing an organic raw material which has a higher saturated vapor pressure than the atmospheric pressure; a first flow rate unit regulating a flow rate of the organic raw material supplied from the fuel vessel; a vaporization unit vaporizing the organic raw material supplied from the first flow rate unit; a reforming unit reforming the organic raw material having vaporized by the vaporization unit, into hydrogen-containing gases; a carbon monoxide removing unit removing at least a part of carbon monoxide contained in the hydrogen-containing gases; a hydrogen purifying unit separating the hydrogen-containing gases supplied from the carbon monoxide removing unit into high density hydrogen gases and low density hydrogen gases other than the high density hydrogen gases, the high density hydrogen gases being ridden of at least parts of carbon dioxide, methane and water vapor; a flame ionization detecting unit detecting measuring object gases ionized by combustion of the high density hydrogen gases supplied from the hydrogen purifying unit; an analysis control unit controlling the flame ionization detecting unit to analyze the measuring object gases; a catalyst combustion unit burning the low density hydrogen gases supplied from the hydrogen purifying unit with a catalytic action and discharging combustion gases; a second flow rate unit regulating a flow rate of the combustion gases discharged from the catalyst combustion unit according to pressure of the organic raw material in the fuel vessel; and a vessel heating unit arranged around the fuel vessel to heat the fuel vessel by using the combustion gases supplied from the second flow rate unit.

According to the third aspect of the invention, a fuel cell system comprises: a fuel vessel storing an organic raw material which has a higher saturated vapor pressure than the atmospheric pressure; a first flow rate unit regulating a flow rate of the organic raw material supplied from the fuel vessel; a vaporization unit vaporizing the organic raw material supplied from the first flow rate unit; a reforming unit reforming the organic raw material having vaporized by the vaporization unit, into hydrogen-containing gases; a carbon monoxide removing unit removing at least a part of carbon monoxide contained in the hydrogen-containing gases; a fuel cell producing electric power by using an air and the hydrogen-containing gases from which at least a part of carbon monoxide is removed by the carbon monoxide removing unit; a catalyst combustion unit burning gases discharged from the fuel cell with a catalytic action and discharging combustion gases; a second flow rate unit regulating a flow rate of the combustion gases discharged from the catalyst combustion unit according to pressure of the organic raw material in the fuel vessel; and a vessel heating unit arranged around the fuel vessel to heat the fuel vessel by using the combustion gases supplied from the second flow rate unit.

According to the above aspects of the invention, there is provided the fuel system and the fuel cell system can stably supply a fuel in a simple structure without making an apparatus or a system large in size.

### BRIEF DESCRIPTION OF THE DRAWINGS

FIG. 1 is a block diagram showing a fuel cell system according to a first embodiment of a fuel system;

FIG. 2 is a view showing the construction of a regulating valve;

FIG. 3 is a view showing a vessel heating unit;

FIG. 4 is a view showing a first modification example of the vessel heating unit;

FIG. 5 is a view showing a second modification example of the vessel heating unit 21;

FIG. 6 is a view showing a third modification example of the vessel heating unit 21;

FIG. 7 is a view showing an analysis system according to a second embodiment of a fuel system; and

FIG. 8 is a view showing an ultra micro-gas turbine system according to a third embodiment.

### DETAILED DESCRIPTION

Various embodiments according to the invention will be described hereinafter with reference to the accompanying drawings.

Embodiments of the invention will be described below with reference to the drawings.

### First Embodiment

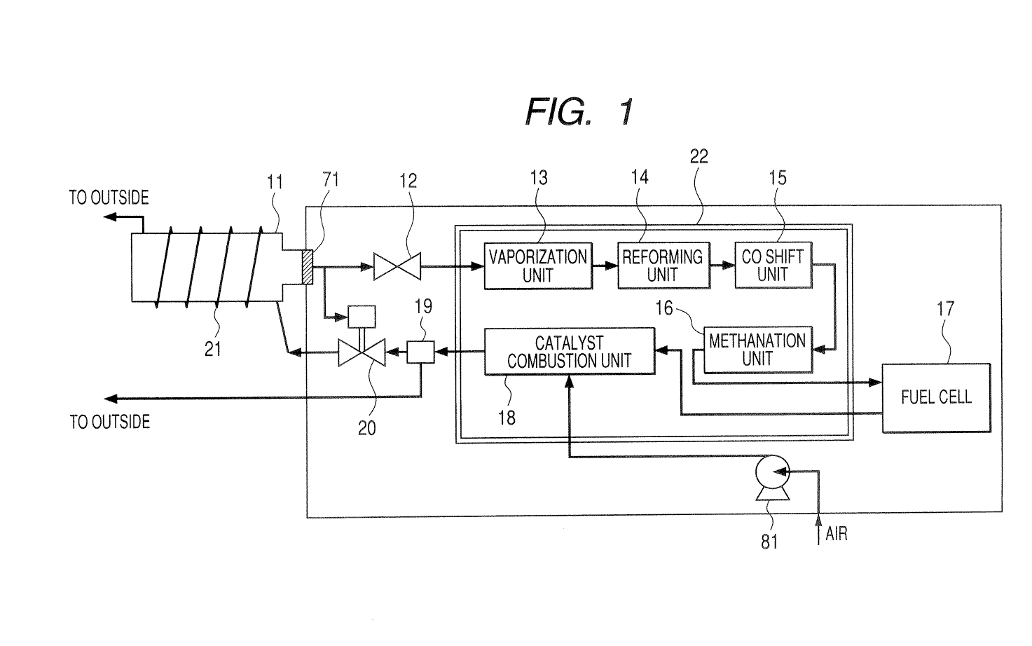

A fuel cell system to which a fuel system according to a first embodiment of the invention is applied will be described with reference to FIGS. 1 to 6.

As shown in FIG. 1, the fuel cell system includes a fuel vessel 11, a fuel flow control unit 12 (first flow rate unit), a vaporization unit 13, a reforming unit 14, a CO shift unit 15, a methanation unit 16, a fuel cell 17, a catalyst combustion unit 18, a branch unit 19, a heating-purpose combustion gas flow regulating valve 20 (second flow rate unit) (hereinafter referred to as “regulating valve 20”), a vessel heating unit 21, and a thermal insulation unit 22.

The fuel vessel 11 stores an organic raw material and water (hereinafter referred to as “fuel”) serving as a fuel for the fuel cell system having a higher saturated vapor pressure than the atmospheric pressure. The fuel flow control unit 12 regulates a flow rate of a fuel supplied from the fuel vessel 11. The vaporization unit 13 is connected to the fuel flow control unit 12 through a pipe or the like and vaporizes the supplied fuel.

The reforming unit 14 is connected to the vaporization unit 13 through a pipe or the like and reforms the vaporized fuel into reformed gases. The CO shift unit 15 is connected to the reforming unit 14 through a pipe or the like and allows the reformed gases to perform shift reaction. The methanation unit 16 is connected to the CO shift unit 15 through a pipe or the like and removes CO remaining in the reformed gases having performed shift reaction.

The fuel cell 17 is connected to the methanation unit 16 through a pipe or the like and allows hydrogen contained in the reformed gases fed from the methanation unit 16 and oxygen contained in the atmosphere to react with each other to generate electric power. The catalyst combustion unit 18 is connected to the fuel cell 17 through a pipe or the like and burns exhaust gases discharged by the fuel cell 17 to feed combustion gases.

The branch unit 19 connected to the catalyst combustion unit 18 through a pipe or the like and divides combustion gases into gases being fed to the regulating valve 20 and gases being discharged outside. The regulating valve 20 is connected to the branch unit 19 through a pipe or the like and regulates a flow rate of combustion gases being fed to a vessel heating unit 21. The vessel heating unit 21 is connected to the regulating valve 20 through a pipe or the like and heats the fuel vessel 11. The thermal insulation unit 22 covers the reforming unit 14, the vaporization unit 13, the CO shift unit 15, the methanation unit 16, and the catalyst combustion unit 18.

Continuously, details of the respective units or parts will be described.

First, the fuel vessel 11 is a pressure vessel including a detachable connection 71, and stores, for example, a mixture of water and dimethyl ether as a fuel, as shown in FIG. 1. The saturated vapor pressure of dimethyl ether at room temperature is about 6 atmospheric pressure higher than the atmospheric pressure. Hereupon, the fuel vessel 11 makes use of the saturated vapor pressure of dimethyl ether higher than the atmospheric pressure to supply a fuel to the vaporization unit 13 without the use of a pump or the like.

As the fuel, a mixture of water and dimethyl ether may be supplied as a fuel to the vaporization unit 13, or water and dimethyl ether may be supplied separately and mixed upstream of or at the vaporization unit 13. In the latter case, pressure of dimethyl ether can be caused to act on water through a partition or the like in the fuel vessel 11 to supply water without the use of a pump or the like. In either case, however, the mole ratio of water and dimethyl ether, which are to be mixed, is desirably between 1:3 and 1:4. Also, when water and dimethyl ether are mixed, methyl alcohol may be added thereto. By addition of methyl alcohol, water and dimethyl ether are improved in compatibility and the liquid phase of water and dimethyl ether becomes uniform in the fuel vessel 11. In this case, methyl alcohol may be added to have a weight ratio of 5 to 10% relative to the mixture. Even when methyl alcohol is added, the mixture is higher in pressure than the atmospheric pressure and the saturated vapor pressure of about 3 to 5 atmospheric pressure at room temperature is obtained.

Other than dimethyl ether, liquefied gases of which the saturated vapor pressure at room temperature is higher than the atmospheric pressure, such as propane, isobutane, normal butane, etc. may be used as a fuel.

Subsequently, the fuel flow control unit 12 is arranged between the fuel vessel 11 and the vaporization unit 13 to regulate a flow rate of a fuel supplied from the fuel vessel 11 to the vaporization unit 13. Orifices, needle valves, bellows valves, diaphragm valves, butterfly valves, etc. may be used for the fuel flow control unit 12. Also, there may be used a combination of orifices having different shapes and a temperature variable type orifice in which a fluid is varied in viscosity through temperature adjustment to regulate a flow rate.

The vaporization unit 13 vaporizes a fuel supplied with a control in flow rate from the fuel flow control unit 12, by using heat of combustion of the catalyst combustion unit 18, and then supplies the fuel to the reforming unit 14.

The succeeding reforming unit 14 includes therein a flow passage (not shown) through which a fuel supplied from the vaporization unit 13 passes. Further, a reforming catalyst (not shown) for promotion of reforming reaction is provided on an inner wall surface of the flow passage, and a fuel supplied from the vaporization unit 13 passes through the flow passage to cause the reforming reaction. Here, the reforming reaction means that a fuel supplied from the vaporization unit 13 is reformed in the flow passage to make gases (hereinafter referred to as “reformed gases”) containing hydrogen.

Subsequently, the CO shift unit 15 includes therein a flow passage (not shown), through which reformed gases supplied from the reforming unit 14 pass. Further, a shift catalyst (not shown) for promotion of shift reaction of carbon monoxide is provided on the inner wall surface of the flow passage, and reformed gases containing carbon monoxide pass through the flow passage to cause the shift reaction. Reformed gases supplied from the reforming unit 14 contain carbon dioxide and carbon monoxide as by-products in addition to hydrogen. The carbon monoxide is responsible for deterioration of an anode catalyst (not shown) of the fuel cell 17 and degradation in power generating capacity of a fuel cell system. Here, the CO shift unit 15 causes that shift reaction, in which carbon monoxide contained in reformed gases is shifted to hydrogen and carbon dioxide, to reduce an amount of carbon monoxide and to achieve an increase in generated hydrogen amount.

Subsequently, the methanation unit 16 includes therein a flow passage (not shown), through which reformed gases supplied from the CO shift unit 15 pass. Further, a methanation catalyst (not shown) for promotion of methanation reaction of carbon monoxide is provided on the inner wall surface of the flow passage, and reformed gases containing carbon monoxide pass through the flow passage to cause the methanation reaction. Reformed gases supplied from the CO shift unit 15 still contain carbon monoxide in the order of 1 to 2%. As described above, carbon monoxide contained in the reformed gases is responsible for degradation in power generating capacity of a fuel cell system. Hereupon, the methanation unit 16 causes that methanation reaction, in which carbon monoxide contained in the reformed gases is converted into methane and water, to remove carbon monoxide before the reformed gases are supplied to the fuel cell 17.

The fuel cell 17 causes reaction between hydrogen contained in reformed gases supplied from the methanation unit 16 and oxygen in the atmosphere to produce water and generate electric power. The exhaust gases contain methane and unreacted hydrogen. Hereupon, the succeeding catalyst combustion unit 18 makes use of oxygen in the atmosphere pumped from an air pump 81, to burn the methane and unreacted hydrogen. The heat of combustion generated at this time is used to heat the vaporization unit 13 and the reforming unit 14.

The thermal insulation unit 22 is mounted in a manner to cover peripheries of the vaporization unit 13, the reforming unit 14, the CO shift unit 15, and the methanation unit 16. Thereby, the vaporization unit 13, the reforming unit 14, etc. are efficiently heated and parts, such as electronic circuits, etc., arranged around the thermal insulation unit 22 and having a low heat resistance are protected from heat of combustion.

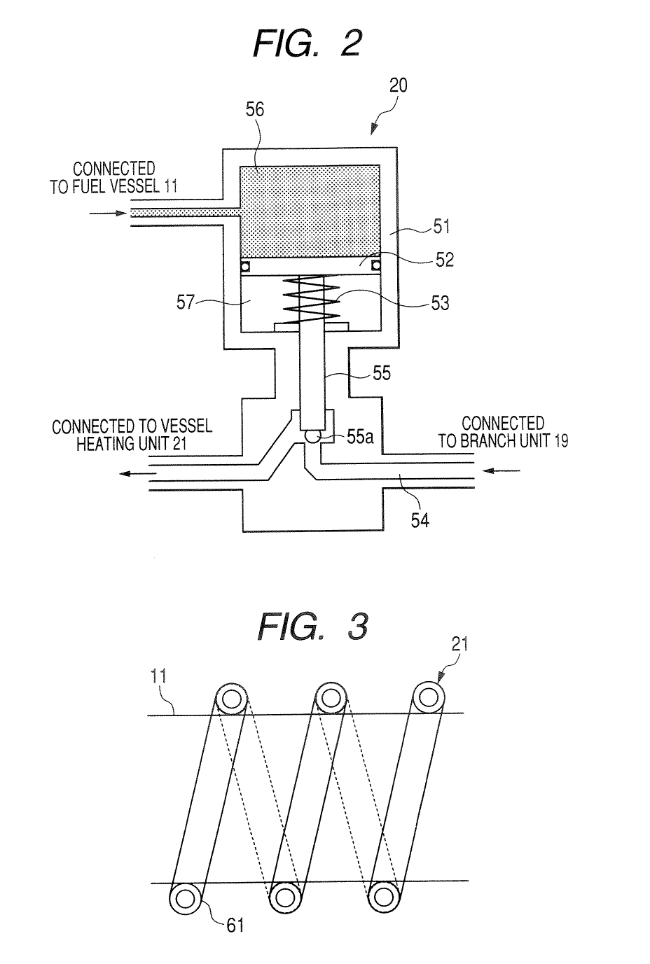

Subsequently, the regulating valve 20 will be described with reference to FIG. 2.

As shown in FIG. 2, the regulating valve 20 is connected to the fuel vessel 11 through a pipe or the like and includes: a valve driving fuel tank 51 to which a part of a fuel is supplied from the fuel vessel 11; a partition 52 that divides the valve driving fuel tank 51 into two halves, that is, a tank upper portion 56 and a tank lower portion 57; a valve rod 55 mounted to a tank lower portion side of the partition 52 to operate as a valve for a heating-purpose combustion gas passage 54; a spring 53 mounted to the valve rod 55 on the tank lower portion side of the partition 52; and the heating-purpose combustion gas passage 54 through which combustion gases discharged through the branch unit 19 from the catalyst combustion unit 18 are supplied to the vessel heating unit 21.

In addition, in the case where combustion gases passing through the regulating valve 20 are too high in temperature, there is a possibility that the valve is broken. Hereupon, a heat exchanger and a cooler may be arranged upstream of the regulating valve 20 at need to decrease combustion gases in temperature.

Continuously, details of the respective units or parts will be described.

First, the valve driving fuel tank 51 is connected to the fuel vessel 11 through a pipe or the like as described above. Also, an interior of the tank is divided into two halves, that is, the tank upper portion 56 and the tank lower portion 57.

A fuel supplied to the tank upper portion 56 of the valve driving fuel tank 51 is caused by pressure in the fuel vessel 11 to bias the partition 52 toward the tank lower portion 57. On the other hand, the spring 53 mounted to an outer periphery of the valve rod 55 on the tank lower portion 57 side of the partition 52 is caused by its elastic force to bias the partition 52 toward the tank upper portion 56. Accordingly, the partition 52 moves in the valve driving fuel tank 51 in a manner to stop in a position, in which a force by pressure in the fuel vessel 11 and the elastic force of the spring 53 balance each other.

The valve rod 55 is mounted at its upper end to the tank lower portion 57 side of the partition 52 to move as the partition 52 moves. Also, a lower end 55a of the valve rod 55 is arranged in a position to control a width of the heating-purpose combustion gas passage 54. The valve rod 55 operates as a valve that controls a width of the heating-purpose combustion gas passage 54 upon movements of the lower end 55a of the valve rod 55.

Subsequently, the spring 53 pushes up the partition 52 to a position, in which it balances a force applied to the partition 52 by pressure of a fuel in the fuel vessel 11, toward the tank upper portion 56 owing to its elastic force. Hereupon, a position, in which a force applied to the partition 52 by pressure of a fuel in the fuel vessel 11 balances the elastic force of the spring 53, that is, a valve opening degree is varied by the elastic force of the spring 53. Since the elastic force of the spring 53 is changed by a value of a spring constant, a flow rate of combustion gases required for maintenance of an interior of the fuel vessel 11 at a desired pressure can be adjusted by regulation of the spring constant. In addition, while FIG. 2 shows an example of a coil spring for the spring 53, leaf springs, air springs, etc. other than this may be used.

The heating-purpose combustion gas passage 54 is provided between the catalyst combustion unit 18 and the vessel heating unit 21 to supply combustion gases discharged from the catalyst combustion unit 18 to the vessel heating unit 21. At this time, a flow rate of combustion gases supplied to the vessel heating unit 21 is varied by positions of the partition 52 and the valve rod 55 connected to the partition 52. More specifically, when the partition 52 and the valve rod 55 are pushed up toward the tank upper portion 56 and a valve opening degree by the lower end 55a of the valve rod 55 becomes large, a flow rate of combustion gases discharged from heating-purpose combustion gas passage 54 increases. Conversely, when the partition 52 and the valve rod 55 are pushed down toward the tank lower portion 57 and a valve opening degree by the lower end 55a of the valve rod 55 becomes small, a flow rate of combustion gases discharged from the heating-purpose combustion gas passage 54 decreases.

Subsequently, the vessel heating unit 21 will be described with reference to FIGS. 3 to 6.

As shown in FIG. 3, the vessel heating unit 21 includes a heating-purpose flow passage pipe 61 connected to the heating-purpose combustion gas passage 54 and wound spirally around the fuel vessel 11. Heating-purpose combustion gases flow into the heating-purpose flow passage pipe 61 of the vessel heating unit 21 to heat the fuel vessel 11. The fuel vessel 11 and the vessel heating unit 21 may not contact with each other, and a distance between the both is preferably small in order to lessen influences of changes in external environmental temperature on an amount of heat transfer.

(First Modification Example of the Vessel Heating Unit 21)

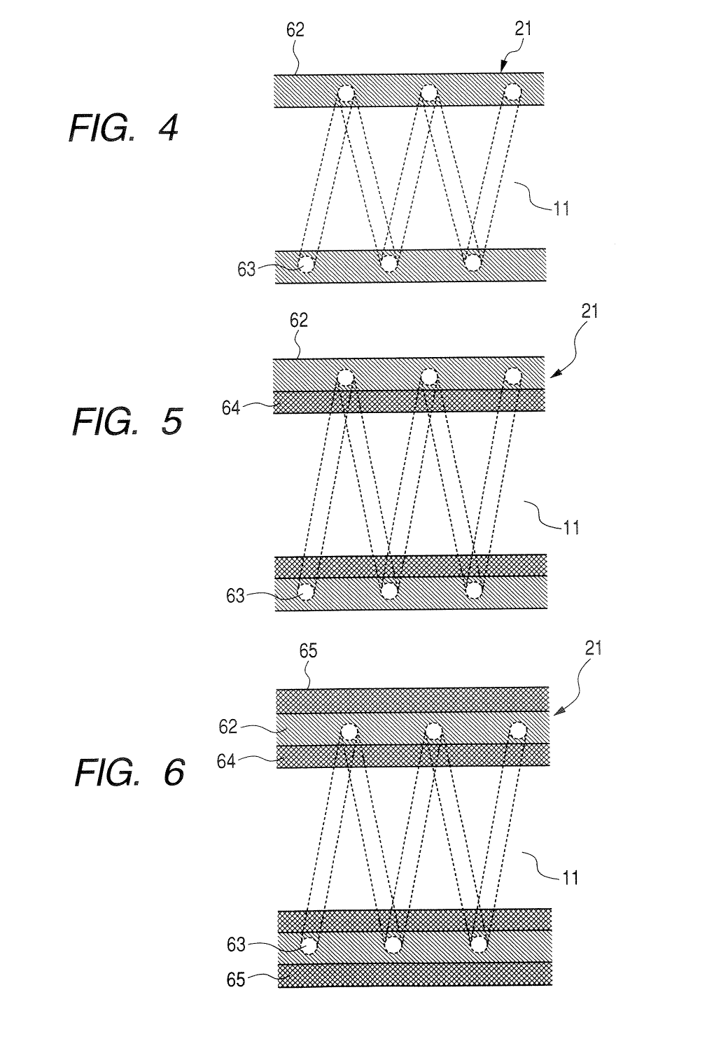

As shown in FIG. 4, the vessel heating unit 21 of this example includes a metallic cylindrical-shaped jacket 62 provided therein with a spiral flow passage 63 is mounted to an outside of the fuel vessel 11. Also, in this example, the fuel vessel 11 and the vessel heating unit 21 may not contact with each other, and a distance between the both is preferably small in order to lessen influences of changes in external environmental temperature on an amount of heat transfer.

(Second Modification Example of the Vessel Heating Unit 21)

As shown in FIG. 5, the vessel heating unit 21 of this example includes a heat insulating material 64 provided between the metallic cylindrical-shaped jacket 62 of the vessel heating unit 21 shown in FIG. 4 and the fuel vessel 11. The fuel vessel 11 and the heat insulating material 64 may not contact with each other, and a distance between the both is preferably small in order to lessen influences of changes in external environmental temperature on an amount of heat transfer.

(Third Modification Example of the Vessel Heating Unit 21)

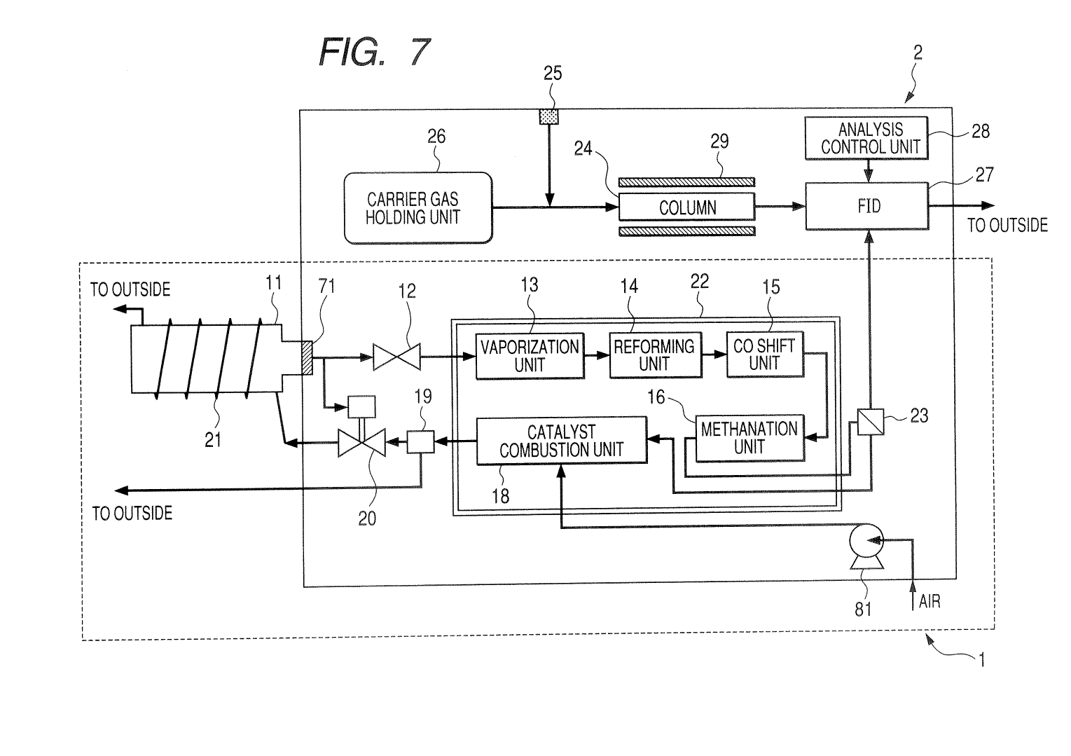

As shown in FIG. 6, the vessel heating unit 21 of this example includes a heat insulating material 65 provided around the metallic cylindrical-shaped jacket 62 of the vessel heating unit 21 shown in FIG. 5. The provision of the heat insulating material 65 around the jacket 62 achieves suppressing heat release of the jacket 62 due to a decrease in external environmental temperature. In addition, while the heat insulating material 65 in this example is provided around the metallic cylindrical-shaped jacket 62 of the vessel heating unit 21 shown in FIG. 5, a heat insulating material 65 may be provided around the jacket 62 of the vessel heating unit 21 shown in FIG. 4.

Subsequently, the fuel cell system according to the embodiment will be described with reference to FIG. 1 or 2.

First, apart of a fuel supplied from the fuel vessel 11 shown in FIG. 1 is supplied to the tank upper portion 56 of the regulating valve 20. At this time, a flow rate of combustion gases passing through the regulating valve 20 is regulated according to pressure in the fuel vessel 11. An operation of the regulating valve 20 will be described later. On the other hand, the remainder of a fuel supplied from the fuel vessel 11 is regulated in flow rate by the fuel flow control unit 12 and then supplied to the vaporization unit 13.

A fuel supplied to the vaporization unit 13 is vaporized using heat of combustion of the catalyst combustion unit 18 and then supplied to the reforming unit 14. A fuel supplied to the reforming unit 14 from the vaporization unit 13 passes through the flow passage provided in the reforming unit 14 to make reformed gases. The reformed gases are supplied to the CO shift unit 15 to pass through the flow passage provided in the CO shift unit 15. Carbon monoxide contained in the reformed gases is shifted to carbon dioxide and hydrogen by the catalyst provided in the flow passage of the CO shift unit 15.

The reformed gases having undergone shift reaction in the CO shift unit 15 are supplied to the methanation unit 16 to pass through the flow passage in the methanation unit 16. Carbon monoxide in the reformed gases is caused by the catalyst provided in the methanation unit 16 to perform methanation reaction to be converted into water and methane. In this manner, reformed gases ridded of carbon monoxide in the methanation unit 16 are supplied to the fuel cell 17.

The fuel cell 17 causes reaction between hydrogen contained in reformed gases supplied from the methanation unit 16 and oxygen in the atmosphere. In keeping with the reaction, the fuel cell 17 produces water, generates electric power, and discharges exhaust gases. The exhaust gases contain the methane and unreacted hydrogen. The exhaust gases are discharged to the catalyst combustion unit 18, and burnt using oxygen in the atmosphere pumped by the air pump 81. The exhaust gases burnt in the catalyst combustion unit 18 become combustion gases to be discharged to the branch unit 19. The combustion gases discharged to the branch unit 19 are partially discharged outside and the remainder thereof is supplied to the regulating valve 20.

The combustion gases supplied to the regulating valve 20 are regulated in flow rate according to pressure in the fuel vessel 11 when passing through the heating-purpose combustion gas passage 54 and supplied to the vessel heating unit 21. The combustion gases supplied to the vessel heating unit 21 heat the fuel vessel 11 to be discharged outside as they are.

Subsequently, an operation of the regulating valve 20 will be described with reference to FIG. 2.

A part of a fuel supplied from the fuel vessel 11 is supplied to the tank upper portion 56 of the valve driving fuel tank 51. At this time, since an interior of the fuel vessel 11 is higher in pressure than the atmospheric pressure, the supplied fuel compresses the spring 53 to push down the partition 52. Thereby, the partition 52 and the valve rod 55 mounted to the partition 52 move to a position, in which a force applied to the partition 52 by pressure of a fuel in the fuel vessel 11 balances the elastic force of the spring 53.

Here, in the case where pressure of a fuel in the fuel vessel 11 decreases, a force with which the partition 52 is pushed down becomes small. Therefore, the partition 52 and the valve rod 55 are pushed up toward the tank upper portion 56 by the elastic force of the spring 53 whereby a valve opening degree by the lower end 55a of the valve rod 55 becomes large and a flow rate of combustion gases supplied to the vessel heating unit 21 from heating-purpose combustion gas passage 54 increases. Thereby, an amount of heat transferred to the fuel vessel 11 increases, a fuel in the fuel vessel 11 rises in temperature, and pressure in the fuel vessel 11 increases.

On the other hand, in the case where pressure of a fuel in the fuel vessel 11 increases, a force with which the partition 52 is pushed down becomes large. Therefore, the partition 52 and the valve rod 55 are pushed down toward the tank lower portion 57 whereby a valve opening degree by the lower end 55a of the valve rod 55 becomes small and a flow rate of combustion gases supplied to the vessel heating unit 21 from heating-purpose combustion gas passage 54 decreases. Thereby, an amount of heat transferred to the fuel vessel 11 decreases, a fuel in the fuel vessel 11 decreases in temperature, and pressure in the fuel vessel 11 decreases.

As described above, according to the first embodiment, a part of a fuel supplied from the fuel vessel 11 is made use of to regulate a flow rate of combustion gases. It is possible to stably supply a fuel from the fuel vessel 11 without making the system large in size, for example, without providing a unit for setting of temperature of the fuel vessel 11, a control circuit that regulates a flow rate of combustion gases according to measured temperature, etc. Also, the regulating valve 20 that regulates a flow rate of combustion gases can be realized in a simple structure including the valve driving fuel tank 51, the partition 52, etc., and also can be driven without electric power. Further, since combustion gases from the catalyst combustion unit 18 are used to heat the fuel vessel 11, the fuel vessel 11 can be heated without burning a fuel again and it is possible to efficiently heat the fuel vessel 11. Also, the jacket 62 is used for the vessel heating unit 21 whereby the vessel heating unit 21 is increased in area of heat transfer surface to enable expediting heating of the fuel vessel 11. Further, since heat conduction of the vessel heating unit 21 itself is also expedited, a heat transfer surface of the vessel heating unit 21 becomes uniform in temperature, so that it is possible to uniformly heat the fuel vessel 11.

### Second Embodiment

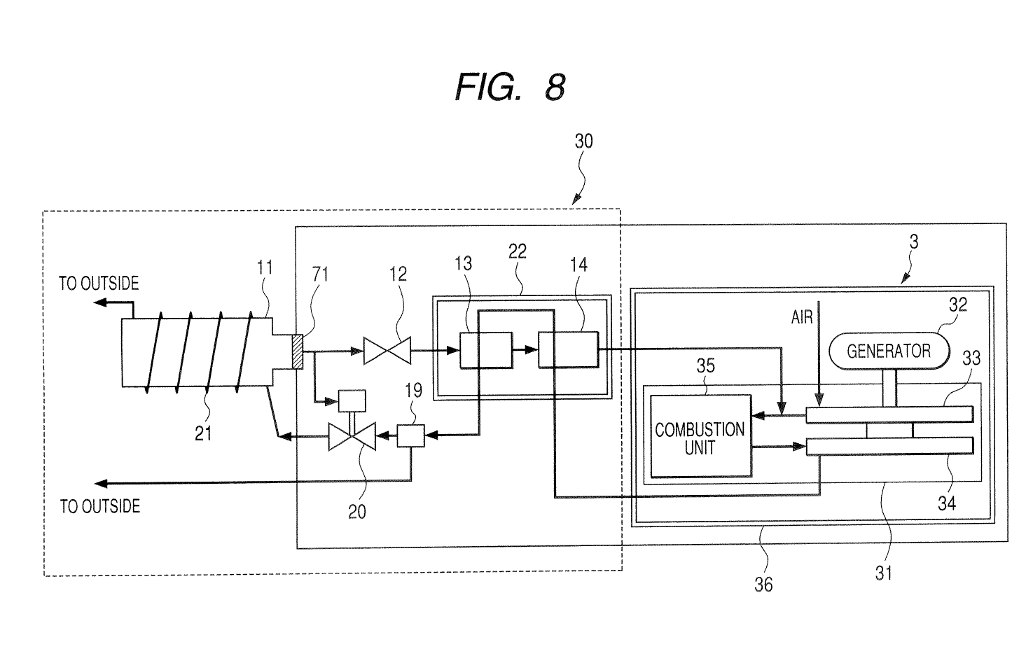

Subsequently, an analysis system to which a fuel system according to a second embodiment of the invention is applied will be described with reference to FIG. 7. The analysis system includes a hydrogen generator 1 and an analysis unit 2 and functions as a portable instrument for analysis.

As compared to the fuel cell system shown in FIG. 1, the hydrogen generator 1 does not include the fuel cell 17 but includes a hydrogen purifying unit 23. In addition, as shown in FIG. 7, the same parts as those in FIG. 1 are denoted by the same reference numerals as those in the latter and an explanation thereon is omitted.

The hydrogen purifying unit 23 provided on the hydrogen generator 1 is connected to a methanation unit 16 through a pipe or the like and connected at its output side to a catalyst combustion unit 18 and FID 27 described later through a pipe or the like. In the hydrogen purifying unit 23, reformed gases supplied from the methanation unit 16 are separated into the following gasses: high density hydrogen gases ridden of carbon dioxide, methane and water vapor; and low density hydrogen gases other than the high density hydrogen gases. The hydrogen purifying unit 23 may include a hydrogen permeable membrane such as metallic film of radium, vanadium, or tantalum, and may include a hydrogen semi-permeable membrane of quartz base.

Subsequently, an explanation will be given to the analysis unit 2.

As shown in FIG. 7, the analysis unit 2 includes: a measuring object gas supply port 25, through which measuring object gases are supplied to a column 24, a carrier gas holding unit 26 that holds inert gases (referred below to as carrier gases) such as helium, nitrogen, etc., the column 24 connected to the measuring object gas supply port 25 and the carrier gas holding unit 26 through a pipe or the like to separate measuring object gases every component, a FID 27 (Flame Ionization Detector) connected to the column 24 and the hydrogen purifying unit 23 through a pipe or the like to burn high density hydrogen gases supplied from the hydrogen purifying unit 23 to ionize measuring object gases supplied from the column 24 to detect the same, and an analysis control unit 28 that controls the FID 27 to analyze the measuring object gases.

In addition, the column 24 includes, for example, a capillary column, a packed column, etc. and is heated by an electric heater 29.

Subsequently, an operation of the fuel system according to the embodiment will be described with reference to FIG. 7. In addition, since operations up to removal of carbon monoxide in reformed gases by the methanation unit 16 are the same as those in the fuel cell system shown in FIG. 1, an explanation thereon is omitted.

Reformed gases, which are ridden of carbon monoxide by the methanation unit 16, are supplied to the hydrogen purifying unit 23 to be separated into high density hydrogen gases being ridden of carbon dioxide, methane and water vapor and low density hydrogen gases other than the high density hydrogen gases. The high density hydrogen gases as separated are supplied to the FID 27 of the analysis unit 2. On the other hand, the low density hydrogen gases as separated are discharged to the catalyst combustion unit 18 to be burnt with the use of oxygen in the atmosphere, which is pumped by the air pump 81, to be discharged to the branch unit 19.

Since an operation after combustion gases are discharged to the branch unit 19 is the same as that of the fuel cell system shown in FIG. 1, an explanation thereon is omitted.

Measuring object gases supplied from the measuring object gas supply port 25 pass through the column 24 together with carrier gases supplied from the carrier gas holding unit 26. The measuring object gases pass through the column 24 to be separated every component and then is supplied to the FID 27. The measuring object gases supplied to the FID 27 are ionized by combustion of high density hydrogen gases supplied from the hydrogen purifying unit 23 to be detected, and analyzed by the analysis control unit 28. After the analysis of the measuring object gases is terminated, the measuring object gases has been decomposed into carbon dioxide and water vapor, and are discharged outside from the FID 27 together with water vapor produced from high density hydrogen gases.

In addition, while the electric heater 29 is used to heat the column 24, a part of heat generated when low density hydrogen gases are burnt in the catalyst combustion unit 18 may be supplied to teat the column 24 by the use of a heat pipe. Also, electric power for driving of the FID 27, the analysis control unit 28, the electric heater 29, etc. may be supplied from a battery or the like. The fuel cell 17 may be mounted in the analysis system and low density hydrogen gases separated by the hydrogen purifying unit 23 may be supplied thereto to produce electric power.

As described above, according to the second embodiment, a part of a fuel supplied from the fuel vessel 11 is made use of to regulate a flow rate of combustion gases. It is possible to stably supply a fuel from the fuel vessel 11 without making the system large in size, for example, without providing a unit for measurement of temperature of the fuel vessel 11, a control circuit that regulates a flow rate of combustion gases, etc. Also, the regulating valve 20 that regulates a flow rate of combustion gases can be realized in a simple structure including the valve driving fuel tank 51, the partition 52, etc., and also can be driven without electric power.

### Third Embodiment

Subsequently, an ultra micro-gas turbine system to which a fuel system according to a third embodiment of the invention is applied will be described with reference to FIG. 8. The ultra micro-gas turbine system includes a hydrogen generator 30 and an electric power generating unit 3.

As compared to the fuel cell system shown in FIG. 1, the hydrogen generator 30 shown in FIG. 8 does not include a fuel cell 17, a CO shift unit 15, a methanation unit 16, and a catalyst combustion unit 18. In addition, the same parts in FIG. 8 as those in FIG. 1 are denoted by the same reference numerals as those in the latter and an explanation thereon is omitted.

Subsequently, an explanation will be given to the electric power generating unit 3.

The electric power generating unit 3 shown in FIG. 8 includes an ultra micro-gas turbine 31 connected to a reforming unit 14 of a hydrogen generator 30, and a generator 32 connected to a turbine 34 provided in the ultra micro-gas turbine 31 to produce electric power owing to driving of the turbine 34.

The ultra micro-gas turbine 31 includes: a compressor 33 to compress an air taken in from outside and supply the compressed air to a combustion unit 35; the combustion unit 35 connected to the reforming unit 14 and the compressor 33 to mix and burn reformed gases with the compressed air to drive the turbine 34; the turbine 34 connected to the generator 32 and driven with combustion heat of the combustion unit 35; and a thermal insulation unit 36 that covers peripheries of the compressor 33, the combustion unit 35, and the turbine 34. The ultra micro-gas turbine 31 may be formed with the use of MEMS (Micro Electro Mechanical System) technology.

Subsequently, an operation of the ultra micro-gas turbine system according to the embodiment will be described with reference to FIG. 8. Since operations up to production of reformed gases in the reforming unit 14 are the same as those in the fuel cell system shown in FIG. 1, an explanation thereon is omitted.

Reformed gases are supplied to the combustion unit 35 from the reforming unit 14. An air compressed by the compressor 33 is also supplied to the combustion unit 35 together with the reformed gases. The combustion unit 35 rotationally drives the turbine 34 with heat, which is provided by mixing the supplied reformed gases and the air to burn the same, and the generator 32 produces electric power on the basis of driving of the turbine 34. Here, the combustion unit 35 mixes reformed gases with an air to burn the same whereby combustion gases are generated. The combustion gases are discharged to the branch unit 19, through a pipe or the like connecting the turbine 34 and the branch unit 19 via the reforming unit 14 and the vaporization unit 13. The combustion gases heat the reforming unit 14 and the vaporization unit 13 and are cooled by heat exchange.

Since operations after combustion gases are discharged to the branch unit 19 are the same as those of the fuel cell system shown in FIG. 1, an explanation thereon is omitted.

As described above, according to the third embodiment, a part of a fuel supplied from the fuel vessel 11 is made use of to regulate a flow rate of combustion gases. It is possible to stably supply a fuel from the fuel vessel 11 without making the system large in size, for example, without providing a unit for measurement of temperature of the fuel vessel 11, a control circuit that regulates a flow rate of combustion gases, etc. Also, the regulating valve 20 that regulates a flow rate of combustion gases can be realized in a simple structure including the valve driving fuel tank 51, the partition 52, etc., and also can be driven without electric power. Further, combustion gases of the combustion unit 35 are used to heat the vaporization unit 13, the reforming unit 14, and the fuel vessel 11, so that it is possible to efficiently heat the fuel vessel 11, etc. without burning a separate fuel.

It is to be understood that the present invention is not limited to the specific embodiment described above and that the invention can be embodied with the elements modified without departing from the spirit and scope of the invention. The present invention can be embodied in various forms according to appropriate combinations of the elements disclosed in the embodiment described above. For example, some elements may be deleted from all elements shown in the embodiment. Further, the elements in different embodiments may be used appropriately in combination.

What is claimed is:

1. A fuel system comprising:
a fuel vessel storing an organic raw material which has a higher saturated vapor pressure than the atmospheric pressure;
a first flow rate unit regulating a flow rate of the organic raw material supplied from the fuel vessel;
a reforming unit reforming at least a part of the organic raw material supplied from the first flow rate unit into hydrogen-containing gases;
a combustion unit burning at least a part of the hydrogen-containing gases supplied from the reforming unit and discharging combustion gases;
a second flow rate unit regulating a flow rate of the combustion gases discharged from the combustion unit according to pressure of the organic raw material in the fuel vessel; and
a vessel heating unit arranged around the fuel vessel to heat the fuel vessel by using the combustion gases supplied from the second flow rate unit.

2. The fuel system according to claim 1, wherein the second flow rate unit includes:
a combustion gas passage through which the combustion gases discharged from the combustion unit are supplied to the vessel heating unit; and
a regulating member defining a width of the combustion gas passage and moved to change the width according to pressure of the organic raw material.

3. The fuel system according to claim 2,
wherein the second flow rate unit further includes a tank connected to the fuel vessel, and
wherein the regulating member includes: a partition provided in the tank, on which pressure of the organic raw material supplied from the fuel vessel is applied; and a valve rod having a first portion mounted to the partition and a second portion defining the width of the combustion gas passage.

4. The fuel system according to claim 3,
wherein the tank includes a first storage portion and a second storage portion divided by the partition, the first storage portion to which the organic raw material supplied from the fuel vessel, and the second storage portion including an elastic body to bias the partition in a direction to the first storage portion, and
wherein the partition being moved to a position, in which the pressure of the organic raw material and an elastic force of the elastic body balance each other, to thereby control the flow rate of the combustion gases supplied to the vessel heating unit through the combustion gas passage.

5. The fuel system according to claim 4,
wherein, in case that pressure of the organic raw material in the fuel vessel increases, the partition and the valve rod are moved in a direction, in which the combustion gas passage is cut off, to decrease the flow rate of the combustion gases supplied to the vessel heating unit through the combustion gas passage, and
wherein, in case that pressure of the organic raw material in the fuel vessel decreases, the elastic force of the elastic body causes the partition and the valve rod to move in a direction, in which the combustion gas passage is opened, to increase the flow rate of the combustion gases supplied to the vessel heating unit through the combustion gas passage.

6. The fuel system according to claim 1, wherein the vessel heating unit includes a jacket with a flow passage having a spiral shape and provided outside the fuel vessel.

7. The fuel system according to claim 6, wherein a heat insulating material is provided between the fuel vessel and the spiral-shaped flow passage.

8. The fuel system according to claim 6, wherein a heat insulating material is provided between the fuel vessel and the flow passage and/or on an outer periphery of the flow passage.

9. The fuel system according to claim 1, wherein the organic raw material contains dimethyl ether.

10. The fuel system according to claim 1,
wherein the combustion unit comprises a micro-gas turbine system, and
wherein the combustion gases discharged from the micro-gas turbine system are cooled by the reforming unit and then supplied to the second flow rate unit.

11. A fuel system comprising:
a fuel vessel storing an organic raw material which has a higher saturated vapor pressure than the atmospheric pressure;
a first flow rate unit regulating a flow rate of the organic raw material supplied from the fuel vessel;
a vaporization unit vaporizing the organic raw material supplied from the first flow rate unit;
a reforming unit reforming the organic raw material having vaporized by the vaporization unit, into hydrogen-containing gases;
a carbon monoxide removing unit removing at least a part of carbon monoxide contained in the hydrogen-containing gases;
a hydrogen purifying unit separating the hydrogen-containing gases supplied from the carbon monoxide removing unit into high density hydrogen gases and low density hydrogen gases other than the high density hydrogen gases, the high density hydrogen gases being ridden of at least parts of carbon dioxide, methane and water vapor;
a flame ionization detecting unit detecting measuring object gases ionized by combustion of the high density hydrogen gases supplied from the hydrogen purifying unit;
an analysis control unit controlling the flame ionization detecting unit to analyze the measuring object gases;
a catalyst combustion unit burning the low density hydrogen gases supplied from the hydrogen purifying unit with a catalytic action and discharging combustion gases;
a second flow rate unit regulating a flow rate of the combustion gases discharged from the catalyst combustion unit according to pressure of the organic raw material in the fuel vessel; and
a vessel heating unit arranged around the fuel vessel to heat the fuel vessel by using the combustion gases supplied from the second flow rate unit.

12. A fuel cell system comprising:
a fuel vessel storing an organic raw material which has a higher saturated vapor pressure than the atmospheric pressure;
a first flow rate unit regulating a flow rate of the organic raw material supplied from the fuel vessel;
a vaporization unit vaporizing the organic raw material supplied from the first flow rate unit;
a reforming unit reforming the organic raw material having vaporized by the vaporization unit, into hydrogen-containing gases;
a carbon monoxide removing unit removing at least a part of carbon monoxide contained in the hydrogen-containing gases;
a fuel cell producing electric power by using an air and the hydrogen-containing gases from which at least a part of carbon monoxide is removed by the carbon monoxide removing unit;
a catalyst combustion unit burning gases discharged from the fuel cell with a catalytic action and discharging combustion gases;
a second flow rate unit regulating a flow rate of the combustion gases discharged from the catalyst combustion unit according to pressure of the organic raw material in the fuel vessel; and
a vessel heating unit arranged around the fuel vessel to heat the fuel vessel by using the combustion gases supplied from the second flow rate unit.

13. The fuel system according to claim 12, wherein the second flow rate unit includes:
a combustion gas passage through which the combustion gases discharged from the combustion unit are supplied to the vessel heating unit; and
a regulating member defining a width of the combustion gas passage and moved to change the width according to pressure of the organic raw material.

14. The fuel system according to claim 13,
wherein the second flow rate unit further includes a tank connected to the fuel vessel, and
wherein the regulating member includes: a partition provided in the tank, on which pressure of the organic raw material supplied from the fuel vessel is applied; and a valve rod having a first portion mounted to the partition and a second portion defining the width of the combustion gas passage.

15. The fuel cell system according to claim 14,
wherein the tank includes a first storage portion and a second storage portion divided by the partition, the first storage portion to which the organic raw material supplied from the fuel vessel, and the second storage portion including an elastic body to bias the partition in a direction to the first storage portion, and
wherein the partition being moved to a position, in which the pressure of the organic raw material and an elastic force of the elastic body balance each other, to thereby control the flow rate of the combustion gases supplied to the vessel heating unit through the combustion gas passage.

16. The fuel cell system according to claim 15,
wherein, in case that pressure of the organic raw material in the fuel vessel increases, the partition and the valve rod are moved in a direction, in which the combustion gas passage is cut off, to decrease the flow rate of the combustion gases supplied to the vessel heating unit through the combustion gas passage, and
wherein, in case that pressure of the organic raw material in the fuel vessel decreases, the elastic force of the elastic body causes the partition and the valve rod to move in a direction, in which the combustion gas passage is opened, to increase the flow rate of the combustion gases supplied to the vessel heating unit through the combustion gas passage.

17. The fuel cell system according to claim 12, wherein the organic raw material contains dimethyl ether.
